(19) United States
(12) Patent Application Publication
(10) Pub. No.: US 2026/0042702 A1
(43) Pub. Date: Feb. 12, 2026

(54) DECORATION FOR GLASS-CERAMIC ARTICLE COMPRISING TALC

(71) Applicant: EUROKERA S.N.C., CHATEAU THIERRY (FR)

(72) Inventors: Caroline FAILLAT, AUBERVILLIERS (FR); Nicolas AULAGNON, CHATEAU THIERRY (FR)

(21) Appl. No.: 19/099,261

(22) PCT Filed: Jul. 28, 2023
(86) PCT No.: PCT/EP2023/071075

§ 371 Date: Jan. 28, 2025

(30) Foreign Application Priority Data
Jul. 29, 2022 (FR) 2207914

(51) Int. Cl. C03C 8/14; C03C 17/02

(52) U.S. Cl. CPC C03C 8/14; C03C 17/02; C03C 2207/00; C03C 2217/213

(57) ABSTRACT

An enamel composition for a glass-ceramic article, includes glass and talc. There is also provided a method for producing the enamel composition, which includes mixing a frit of glass and talc, and optional attrition of the mixture obtained.

The invention relates to the field of glass-ceramics. More precisely, it relates to a glass-ceramic article, intended in particular to cover or receive heating elements and/or intended to serve as a furniture surface, optionally in combination with heating elements. An example of such an item is a hob, oven door, fireplace insert, firewall, or central island for a kitchen or dining room.

A glass-ceramic article is defined as an article based on a substrate of glass-ceramic material, such as a glass-ceramic plate, said substrate possibly being provided with accessories or additional decorative or functional elements. The article may refer to the substrate alone, or to the substrate with additional equipment. For example, the article may designate a hob fitted with a control panel and/or heating elements.

### PRIOR ART

There are several commonly used glass-ceramic products, in particular glass-ceramic hobs, which have proved very popular with home goods retailers, appliance manufacturers, and end-users. This success is explained in particular by the attractive appearance of such hobs and by the ease of cleaning them.

A glass-ceramic is originally a glass, known as a precursor glass, mother glass, or green-glass, the specific chemical composition of which makes it possible to cause a controlled crystallization by suitable heat treatments, known as ceramization treatments. This specific, partly crystallized structure gives the glass-ceramic unique properties.

There are currently different types of glass-ceramics, each variant being the result of major studies and numerous tests, given that it is very difficult to make changes on these plates and/or to their method of obtaining without risking an unfavorable effect on the desired properties.

In particular, in order to be used as a cooking hob, a glass-ceramic hob must generally have a transmission in the visible wavelength range that is both sufficiently low to mask at least part of the underlying heating elements at rest and sufficiently high so that, depending on the type of heating, the user can visually detect the heating elements in operation for safety purposes. A glass-ceramic hob must have high transmission in the infrared wavelength range, particularly in the case of radiant hobs. It must also have sufficient mechanical strength for the field of application of such hobs. In particular, to be suitable for use as a hob, a glass-ceramic hob must have good resistance to pressure as defined in EN 60335-2-6, as well as to impact.

The most common glass-ceramic hobs are dark in color, especially black or brown or orange-brown. They are generally decorated on the top with enamel to delimit the cooking zones and functional keys, and to protect the glass-ceramic from wear and tear. The use of black enamel is particularly attractive, as it offers a low-contrast appearance with a black glass-ceramic hob.

An enamel is usually a mineral layer formed by firing an enamel composition comprising a glass frit and pigments.

As a result, enamels have much higher thermal, abrasion, peeling, and chemical resistance properties than conventional decorative elements such as paint, enabling them to be used on glass-ceramic articles, particularly hobs.

However, the pigmentation of enamels based on commercially available black pigments, such as spinel CoCrFeNi or CuCr, results in tints that tend to be brown. Furthermore, for patterned decors, these enamels are likely to be streaked after cleaning the plate with a dry cloth. These drawbacks are particularly noticeable in enamels formulated from DEC146 glass frit, as described in FR 2 701 473 A1.

In addition, the accumulation of food deposits on enamelled glass-ceramics can lead to enamel peeling off due to temperature, particularly for enamels formulated from DEC146 glass frit and more particularly for enamels made from IB2 glass frit as described in application FR 3 012 130 A1.

Document FR 2 457 312 A1 describes self-cleaning coating compositions, in particular for the inner walls of an oven, comprising an oxidation catalyst, an oil and grease polymerization inhibitor and a binder, wherein the action of the oxidation catalyst enables self-cleaning by volatile oxidation of oils and greases on the walls of an oven. According to this document, the oil and grease polymerization inhibitor makes it possible to lower the temperature at which self-cleaning takes place. Talc is one of these inhibitors. This document therefore does not take into account any of the particular aspects associated with the use of talc in a glass-ceramic plate enamel, such as the mechanical properties required or aesthetic considerations, particularly in terms of color.

Document FR 2 858 974 A1 addresses the problem of the brown color of enamels based on black pigments. According to this document, this coloration is due to the zinc oxide present in the flux, chemically reacting during firing with the surface of commercially available black pigments. To solve this problem, this document proposes the use of a enamel based on a colorless frit and a glass-coated black pigment in a weight proportion of 0% to 10%. The disadvantage of this solution, however, is that it requires special processing techniques, making the enamel manufacturing method more complex and incurring additional costs.

There remains a need for easily accessible enamel compositions for glass-ceramic ware with a black color and satisfactory mechanical properties, in particular in that the enamels obtained do not become marked when used, for example on contact with fingernails or dry cloths, and enable food deposits to be cleaned with reduced peel-off.

### OVERVIEW OF THE INVENTION

The aim of the present invention is to meet these needs by providing such enamel compositions. As can be seen from the present text, the inventors have demonstrated that the incorporation of talc into enamel compositions makes it possible to obtain black-colored enamels that do not become marked when used, and offer improved resistance to tearing.

The invention is quite surprising from a tribological point of view, as talc has a very low hardness, in contrast, for example, to the pigments usually used in enamels.

Talc also has the advantage of being an abundant and inexpensive raw material.

This solution is easily transposable to existing enamel formulations, since it does not require any significant change in the enamel manufacturing method, nor does it entail any significant increase in cost.

Thus, according to a first aspect, the invention relates to an enamel composition for glass-ceramic article comprising glass and talc.

A enamel composition can refer to both a pre-firing and a post-firing enamel. Thus, the term “glass”, in a enamel composition according to the invention, refers, before firing, to a glass frit and after firing, to a glass matrix obtained by melting the glass frit. Enamels according to the invention are typically obtained by firing above 850° C. and preferably above 900° C.

### BRIEF DESCRIPTION OF THE DRAWINGS

Other features and advantages of the present invention will become apparent from the description given below, with reference to the appended drawings that illustrate exemplary embodiments thereof, devoid of any limiting character. In the figures:

FIG. 1 is a colorimetric diagram presenting the data relating to Examples 1 to 4 according to the invention and to Comparatives 1 and 2. This diagram comprises two parts: a two-dimensional first part according to the colorimetric coordinates a* and b*, schematically divided into 4 color ranges (yellow, red, blue and green) and a one-dimensional second part, represented by the L* coordinate of the samples, representative of the brightness of the sample's hue, i.e. the closer L* is to 0, the darker the sample appears.

FIG. 2 shows photographs of enamel-coated glass-ceramic plate samples, illustrating scores of 0, 2 and 4 for the so-called “fingernail mark” test set out in the application examples.

FIG. 3 shows the results obtained for examples 1 to 4 according to the invention for this same test.

FIG. 4 shows photographs of Comparative 3 and Example 5 according to the invention after the peeling test described in the application examples.

### DESCRIPTION OF EMBODIMENTS OF THE INVENTION

In a particular embodiment, the enamel composition according to the invention comprises a frit of glass and talc. According to this embodiment, the composition according to the invention may further comprise an organic medium.

Said organic medium allows the desired viscosity to be set for application to the substrate and enables bonding to the substrate. This medium, chosen in order to ensure good suspension of the particles (of frit and talc) and that must be consumed at the latest during the baking of the enamel, may be any medium or organic binder customarily used in the conventional enamel compositions and may in particular comprise solvents, diluents, oils such as pine oil and other plant oils, resins such as acrylic resins, petroleum fractions, film-forming substances such as cellulose substances, etc.

In particular, an organic medium suitable for the present invention may comprise at least one compound selected from glycols and pine oils. Preferably, said organic medium comprises at least one glycol such as 2-(2-butoxyethoxy) ethanol or 2-butoxyethanol.

The proportion of medium in the ready-to-deposit composition can be between 40% and 60% by weight of said composition, preferably between 45% and 55% by weight. The enamel composition before deposition onto a glass-ceramic substrate is therefore generally in the form of a stable liquid-solid mixture, of pasty consistency, with a viscosity suitable for the deposition method in particular adapted to screen printing.

In another embodiment, the enamel composition according to the invention comprises a vitreous matrix and talc.

A composition according to the invention may comprise talc, in a proportion ranging from 5% to 40% by weight, in particular from 7% to 35% by weight and preferably from 10% to 30% by weight, relative to the total weight of the enamel.

A composition according to the invention may comprise less than 1% by weight of pigments, for example less than 0.5% by weight, in particular less than 0.1% by weight of pigment relative to the total weight of the enamel, and preferably the enamel is pigment-free.

In this way, the present invention can simplify enamel composition, since a black enamel can be obtained by simply mixing a frit of glass and talc, without adding pigment. However, a conventional black enamel formulation may require the use of additional pigments in addition to black pigments to compensate for certain shades of tint.

An enamel composition according to the invention can be obtained from a mixture of frit of glass and talc with a D90 of less than 20 μm, in particular less than 15 μm and preferably less than 10 μm.

That is, in this case, 90% of the particles making up the mixture of glass frit and talc have a diameter of less than 20 μm, in particular less than 15 μm and preferably less than 10 μm.

As demonstrated in the examples below, the inventors have observed that a reduction in the diameter of the particles, i.e. the particle size, making up said mixture enhances the effects of the invention. In this way, an enamel composition comprising frit of glass and talc with a fine particle size as described in the previous paragraph can achieve an even darker enamel color and an enamel that is even less susceptible to marking than an equivalent enamel composition with a higher particle size.

In addition, such a fine particle size also makes it possible to achieve greater enamel abrasion resistance than that observed for an equivalent enamel composition with a higher particle size.

In a particular embodiment of the invention, the composition according to the invention comprises glass of the following composition
SiO₂: 35-50%
B₂O₃: 23-30%
Al₂O₃: 10-22%
Li₂O: 1-3%
Na₂O: 0-3%
K₂O: 2-5%
Li₂O+Na₂O+K₂O: <8%
CaO: 1-5%
CaO+MgO+ZnO+BaO+SrO: <7%
TiO₂: 0-2%
ZrO₂: 0-5%
   the proportions being expressed as percentages by weight relative to the total weight of glass.

Such a glass composition corresponds to a glass frit known as “DEC146” and is described in application FR 2 701 473 A1. For an enamel composition according to the invention containing a glass composition as described above, among the effects of the invention described above, the addition of talc particularly improves the mark resistance of the enamel.

According to this embodiment, the glass can have a coefficient of thermal expansion less than or equal to 60×10⁻⁷ K⁻¹, in particular less than or equal to 56×10⁻⁷ K⁻¹.

Also according to this embodiment, the glass can have a softening point T_{L} above 650° C., in particular above 680° C.

Also according to this embodiment, the composition according to the invention may comprise talc, in a proportion ranging from 15% to 40% by weight, in particular from 17% to 35% by weight and preferably from 20% to 30% by weight, relative to the total weight of the enamel.

In another embodiment of the invention, the enamel composition comprises glass of the following composition, the proportions being expressed as weight percentages relative to the total weight of glass:
SiO₂ 45-60%, preferably 50-58%,
Al₂O₃ 12-22%, preferably 15-19%,
B₂O₃ 12-22%, preferably 15-19%,
Li₂O 0-5%, preferably >0-5%,
Na₂O 0-2%,
K₂O>2%,
CaO 0-4%, preferably 0-2%,
MgO 0-4%, preferably >0-4%,
ZnO 0-4%, preferably >0-4%,
BaO 0-4%, preferably >0-4%,
ZrO₂ 0-4%, in particular 0-2% and preferably >0-2%
TiO₂ 0-1%, preferably 0-0.5%,
   the sum of the proportions of the oxides
CaO+MgO+BaO+SrO+ZnO
   is furthermore less than or equal to 10%, and preferably between 2% and 8%.

Such a glass composition corresponds to a glass frit known as “IB2” and is described in application FR 3 012 130 A1. For an enamel composition according to the invention containing a glass composition as described above, among the effects of the invention described above, the addition of talc particularly improves the peeling resistance of the enamel.

According to this embodiment, the composition according to the invention may comprise talc, in a proportion ranging from 5% to 30% by weight, in particular from 7% to 20% by weight and preferably the enamel comprises talc in a proportion from 10% to 20% by weight, relative to the total weight of the enamel.

According to a second aspect, the invention relates to a method for obtaining an enamel composition according to the invention, comprising mixing a frit of glass and talc, and optionally attrition of the mixture obtained for a period ranging from 5 minutes to 1 hour, in particular from 15 minutes to 45 minutes and preferably from 20 minutes to 40 minutes.

“Attrition” means grinding using a mill or microgrinder by attrition, particularly in an alcoholic medium. An example of such a microgrinder is the one marketed under the reference “Mill PE075” by the company Netzsch.

Attrition enables a mixture of frit of glass and talc particles of known particle size to be reduced, in particular to obtain a D90 of less than 20 μm, in particular less than 15 μm and preferably less than 10 μm.

According to a third aspect, the invention relates to a glass-ceramic article comprising at least one substrate, such as a glass-ceramic plate, said substrate being at least partly coated with an enamel composition according to the invention.

The substrate is generally a plate, particularly intended:
to be used with, in particular to cover or receive, at least one light source and/or heating element, or
for use as a furniture surface or fireplace insert.

Said substrate generally has a shape selected from the following: Rectangular, in particular square, circular and oval. It generally features:
a face turned towards the user in the position of use, known as the visible or external face, which may correspond to the upper face in the position of use,
a second face, opposite the outer face, known as the inner face, generally hidden in the position of use, for example in a furniture frame or cabinet,
which may correspond to the lower face in the position of use, and
an edge, or thickness.

The upper or outer face is generally flat, but may also locally have at least one raised area and/or at least one recessed area and/or at least one opening and/or beveled edges. These variations in shape can constitute continuous variations in the plate.

The lower or inner face can also be flat and smooth or provided with teardrops.

The thickness of the glass-ceramic substrate is generally at least 2 mm, in particular at least 2.5 mm, and is advantageously less than 15 mm, in particular from 3 to 15 mm, in particular from 3 to 8 mm or from 3 to 6 mm.

The substrate can be based on any glass-ceramic, and advantageously has a coefficient of thermal expansion (CTE) of zero or almost zero, in particular lower (in absolute value) than 30×10⁻⁷ K⁻¹ between 20° C. and 700° C., in particular lower than 15×10⁻⁷ K⁻¹, or even lower than 5×10⁻⁷ K⁻¹ between 20° C. and 700° C.

In particular, a black or brown substrate is used, allowing, in combination with light sources placed underneath, to display luminous zones or decorations, while masking any underlying elements. In particular, it can be based on a black glass-ceramic comprising crystals with a β-quartz structure within a residual vitreous phase, the absolute value of its coefficient of thermal expansion advantageously being less than or equal to 15×10⁻⁷ K⁻¹, or even 5×10⁻⁷ K⁻¹, such as the glass-ceramic plates marketed under the name Kerablack+ by Eurokera.

It may in particular be an arsenic-fined glass-ceramic with a composition as described in patent applications EP0437228 or U.S. Pat. No. 5,070,045 or FR2657079, or a tin-fined glass-ceramic having a content of arsenic oxides preferentially less than 0.1%, as described for example in patent application WO 2012/156444, or else a sulfide-fined glass-ceramic as described in patent application WO 2008/053110, etc.

If required, the substrate can be coated with other functional and/or decorative coatings or layers, particularly deposited in areas other than those coated with the enamel according to the invention, such as the usual patterns based on other enamels or an opacifying paint layer on another part of the substrate, or at least one functional layer such as an anti-scratch layer, an anti-spatter layer, an opacifying layer, etc.

The article according to the invention can further comprise, associated or combined with the substrate, at least one light source and/or at least one heating element chosen from radiant or halogen elements, atmospheric gas burners, and induction heating means.

The light source may be integrated into or coupled to at least one display unit structures, an electronic control panel with touch-sensitive controls and a digital screen, etc. Those light sources are advantageously formed by displays consisting of light-emitting diodes that are spaced apart to some extent, the diodes optionally being associated with at least one optical guide.

The article according to the invention can also be combined with at least one additional functional element, such as a frame, connector, cable or control elements.

In particular, the article according to the invention has a good thermal resistance compatible with the use of various types of heaters, and does not pose problems of maintenance, scratches or abrasion as previously indicated, particularly when compared to a glass-ceramic article comprising a typical enamel.

According to a fourth aspect, the invention relates to a method for obtaining a glass-ceramic article according to the invention, comprising:
a. providing a glass-ceramic substrate,
b. printing, in particular screen-printing, an enamel composition according to the invention onto said substrate, and
c. ceramizing the assembly of the substrate and the enamel,
   in particular, the ceramization step comprises heating the substrate and enamel assembly at a temperature of 650° C. to 830° C., preferably for 5 to 90 minutes, then at a temperature of 850° C. to 1100° C., preferably for 5 to 30 minutes.

The manufacture of glass-ceramic plates generally takes place as follows: the glass of the composition chosen to form the glass-ceramic is melted in a melting furnace, the molten glass is then rolled into a standard ribbon or sheet by making the molten glass pass between rolling rolls and the glass ribbon is cut to the desired dimensions. The plates cut in this manner are decorated with an enamel-based decoration applied by screen-printing or enamel spraying, and then ceramized in a manner known per se. Ceramizing consists in firing the plates according to the chosen thermal profile to transform the glass into a polycrystalline material called glass-ceramic, which has a zero or near-zero coefficient of expansion and can withstand a thermal shock of up to 700° C. Ceramizing generally comprises a step of progressive temperature increase, for example up to a “nucleation plateau” temperature of 650° C. to 830° C., which can last from 5 to 90 minutes. The temperature is then raised again to allow crystals to grow, up to a so-called “crystal growth plateau” temperature of, for example, 850° C. to 1100° C., preferably 900° C. to 1000° C., for opalescent and opaque glass-ceramics, maintained for example for 5 to 30 minutes. Finally, the plate is rapidly cooled to room temperature.

Where appropriate, the process also includes a cutting operation, for example using a water jet or mechanical scoring using a scoring wheel, followed by a shaping operation, for example by grinding or beveling. Preferably, this cutting operation is performed prior to ceramizing.

The enamel is deposited on the glass-ceramic substrate prior to ceramizing. This deposition is made by printing, for example digital printing or screen printing.

A screen printing method comprises the deposition, in particular using a squeegee, of a pasty liquid onto the glass sheet through meshes of a screen-printing screen. The apertures of the screen are blocked off in the portion corresponding to the zones of the glass sheet which are not to be coated, such that the paste can only pass through the screen in the zones to be printed, according to a predefined design. Selective blocking of the apertures is therefore done according to the negative of the design to be printed.

This selective blocking is generally carried out by application on the screen of a photo-crosslinkable resin and then by irradiating, by ultraviolet radiation, the parts of the screen to be blocked.

Selective exposure is achieved, for example, by means of an LED that emits ultraviolet radiation, which is computer-controlled so as to obstruct the screen mesh to match a selected image file.

The mesh of the screen is chosen according to the viscosity and the surface tension of the paste as well as according to the desired thickness for the resulting layer of the deposition by screen printing.

The following examples are representative of, but not limited to, the invention described above.

### EXAMPLES

The following examples illustrate the results obtained with glass-ceramic articles and enamels according to the present invention (examples 1 to 8) in comparison with reference examples involving different earlier glass-ceramic articles and enamels (comparatives 1 to 4). The compositions of the enamels included therein are detailed in the following Tables 1 and 2, where the contents of each compound are expressed in percentage by weight, relative to the total weight of the enamel. The enamels were tested for two different types of frit: DEC146 as described in application FR 2 701 473 A1 and IB2 as described in application FR 3 012 130 A1. For IB2, two different glass frit grain sizes were tested.

TABLE 1

| | | Comp. 1 | Comp. 2 | Comp. 3 | Comp. 4 |
|---|---|---|---|---|---|
| Glass frit | DEC146 | 70 | 80 | — | — |
| | IB2 | — | — | 100 | 100 |

| | | | | |
|---|---|---|---|---|
| Black pigment | 16 | 18 | — | — |
| Blue pigment | 14 | 2 | — | — |
| Attrition (min) | 35 | 35 | — | — |
| D90 (μm) | 4.5 | 5 | 3.4 | 10.9 |
| L* | 6.54 | 7.11 | 0.58 | 0.56 |
| a* | 0.76 | 1.41 | 0.03 | −0.01 |
| b* | −1.32 | 0.17 | −0.49 | −0.50 |

TABLE 2

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Glass | DEC 146 (D90 ≤ | 70 | 70 | 80 | 80 | — | — | — | — |
| frit | 9.5 μm) | | | | | | | | |
| | IB2 (D90 = 3.4 μm) | — | — | — | — | 90 | — | — | — |
| | IB2 (D90 = 10.9 μm) | — | — | — | — | — | 90 | 70 | 80 |

| | | | | | | | | |
|---|---|---|---|---|---|---|---|---|
| Talc (DC8345 from Normag | 30 | 30 | 20 | 20 | 10 | 10 | 30 | 20 |
| GmbH) (D90 = 30 μm) | | | | | | | | |
| Attrition (min) | — | 35 | — | 35 | 120 | 120 | 120 | 120 |
| D90 (μm) | — | 9.6 | — | 8.4 | 4.7 | 4.9 | 6.3 | 6.3 |
| L* | 7.20 | 6.18 | 7.68 | 3.44 | 0.8 | 0.87 | 8.20 | 2.67 |
| a* | −0.20 | −0.04 | −0.33 | −0.10 | −0.01 | −0.03 | 0.11 | −0.01 |
| b* | −3.53 | −4.04 | −3.60 | −3.57 | −0.6 | −0.77 | −2.12 | −1.05 |

Tables 1 and 2 also show several parameters specific to the enamels obtained and detailed below.

For each example, a mixture is created between the glass frit and the pigments or talc. If desired, this mixture is then ground using an attrition microgrinder (“Mill PE075” from Netzsch) in an alcoholic medium, containing zirconium oxide beads with a diameter of 1 mm (reference “Zetabeads Plus” from Netzsch).

The particle size of the resulting mixture, whether attrited or not, is then measured using a reference “Mastersizer 3000” laser granulometer from Malvern.

The mixture is then screen-printed on Kerablack+ mother glass from Eurokera S.N.C. and fired in a ceramics cycle at 930° C.

The colorimetric parameters L*, a* and b*, defined in the CIE colorimetric system, are evaluated in a known way, using a Byk-Gardner Color Guide 45/0 colorimeter with reflection colorimetry.

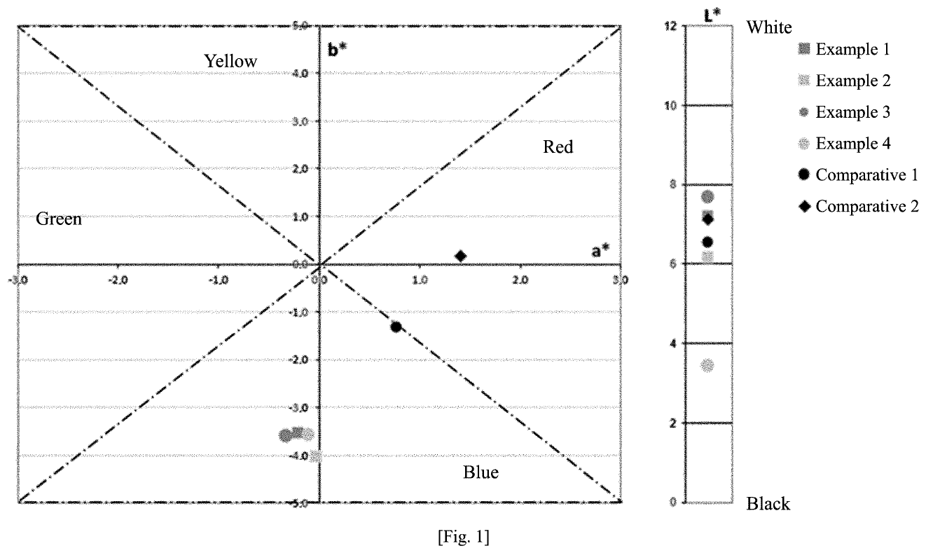

All the colorimetric data from examples 1 to 4 according to the invention and from comparatives 1 and 2, all containing DEC146 glass frit, are also shown in the colorimetric diagram in FIG. 1.

Comparatives 1 and 2, containing black and blue pigments, both show a brown colorimetry trend, i.e. an a* coordinate greater than 0.7, particularly marked for comparative 2.

Examples 1 to 4, containing the same glass frit as comparatives 1 and 2 but devoid of pigments, have a* coordinates that vary little based on the amount of talc and their particle sizes, between 0 and −0.3, resulting in a less brown hue than the enamels in comparatives 1 and 2.

Similarly, the b* coordinate of examples 1 to 4 according to the invention is stable, between −3.53 for example 1 and −4.04 for example 2, for which attrition seems to result in a slight shift in colorimetry towards bluer hues.

Finally, attrition influences the luminosity of enamels. Specifically, comparing examples 1 and 2 or 3 and 4, a decrease in the L* coordinate can be observed in cases where attrition has been carried out. This effect is all the more marked for example 4, which has a frit/talc ratio of 80/20.

Enamel compositions according to the invention therefore enable a satisfactory dark shade to be obtained, in particular when they have a D90 less than or equal to 10 μm and/or a talc content of 20% by weight relative to the total weight of the enamel.

For enamel compositions containing IB2 glass frit, comparatives 3 and 4 made from 100% IB2 glass frit have a neutral black hue. Examples 5 and 6 to 8 have the advantage that their colorimetry is very close to that of the talc-free compositions to which they refer, i.e. comparatives 3 and 4 respectively.

Tables 3 and 4 below show the tests carried out for each of the compositions presented above.

TABLE 3

| | Comp. 1 | Comp. 2 | Comp. 3 | Comp. 4 |
|---|---|---|---|---|
| Rt (μm) | 4.0 ± 0.4 | 2.7 ± 0.5 | 1.2 ± 0.2 | 2.2 ± 0.4 |
| Ra (μm) | 0.31 ± 0.02 | 0.23 ± 0.01 | 0.11 ± 0.01 | 0.26 ± 0.03 |
| 60° gloss | 37.3 | 44.0 | 88.0 | 69 |
| Fingernail | 2 | 2 | 0 | 0 |
| mark test | | | | |
| Peeling | 2.5 | — | 4 | 3 |

TABLE 4

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Rt (μm) | 5.6 ± 0.5 | 2.5 ± 0.2 | 6.2 ± 0.4 | 1.9 ± 0.3 | 1.2 ± 0.4 | 1.5 ± 0.2 | 3.1 ± 0.4 | 1.3 ± 0.4 |
| Ra (μm) | 0.74 ± 0.04 | 0.24 ± 0.03 | 1.80 ± 0.05 | 0.16 ± 0.02 | 0.12 ± 0.02 | 0.14 ± 0.01 | 0.28 ± 0.02 | 0.13 ± 0.01 |
| 60° gloss | 33.4 | 60.1 | 51.0 | 83.0 | 88.0 | 81.0 | 32.0 | 78.0 |
| Fingernail | 1 | 0 | 1 | 0 | 0 | 0 | 1 | 0 |
| mark test | | | | | | | | |
| Peeling | — | 2 | — | 1 | 1 | — | 1 | 2 |

Measurements of total roughness Rt and average roughness Ra are obtained using a Mitutoyo Sj-400 roughness tester to ISO 97 standard over an evaluation length of 4 mm at 5 points on 5 cm square flat areas screen-printed on a 9×9 cm substrate.

Gloss measurements at 60° are carried out using a Byk-Gardner Spectro-Guide 45/0 Gloss colorimeter in accordance with ISO 2813. The results of these measurements are expressed in gloss units (GU). The higher the gloss value, the glossier the observed sample. Conversely, a lower value is representative of a sample's dullness.

Generally speaking, the reduction in grain size in talc-based enamels results in an increase in gloss and a reduction in roughness.

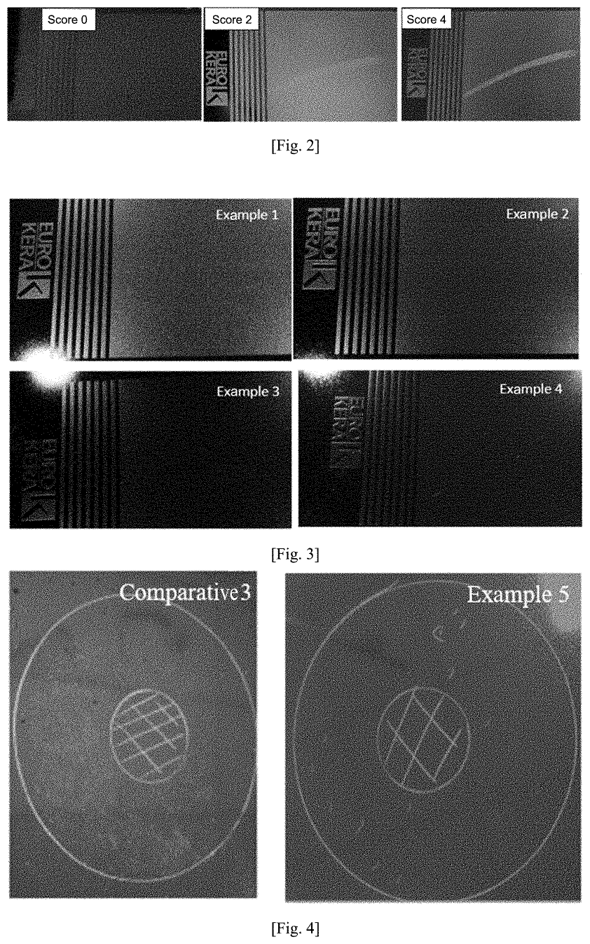

The samples also underwent a “fingernail mark” test, carried out on an enamel plate fully covering a glass-ceramic substrate. This test involves moving the index fingernail over a distance of 5 cm. A score from 0 to 4 is then assigned to the sample based on the mark left on the enamel. A score of 0 indicates a enamel with no mark at all, while a score of 4 indicates a enamel with a very pronounced mark. FIG. 2 shows photographs of representative samples of notes 0, 2 and 4. A score of 0 or 1 meets consumers' expectations in terms of the sensitivity of enamels to marks, such as rag marks. FIG. 3 shows the results obtained for examples 1 to 4 according to the invention.

It can therefore be seen that while the comparative enamels 1 and 2 have a rating of 2, which is considered unsatisfactory, the talc-based enamels, comprising the same glass frit, of examples 1 to 4 have a lower rating of 1 or even 0 for enamels in which the mixture of frit and talc has undergone attrition (examples 2 and 4). The presence of talc in these enamels means they perform better in terms of mark sensitivity.

As regards enamels containing an IB2 glass frit, those in comparative examples 3 and 4 already have a satisfactory rating. It should be noted, therefore, that the addition of talc enables satisfactory mark sensitivity to be maintained.

The results presented above also demonstrate that talc content has little impact on enamel sensitivity to marks, since equivalent results are obtained for examples 1 and 3 (respectively 20% and 30% talc by weight), 2 and 4 (respectively 20% and 30% talc by weight) and 6 and 8 (respectively 10% and 20% talc by weight) according to the invention.

In addition, as observed by comparing examples 1 and 2 or 3 and 4 according to the invention, the reduction in particle size resulting from attrition provides better performance in terms of the mark sensitivity of talc-containing enamel.

The peeling test simulates the cleaning of burnt food build-up on a glass-ceramic hob decorated with enamel. It is carried out on a zone heated by an inductor and consists in placing a mixture of different foods (ground beef, cheese, sugar, eggs, milk, flour, tomato sauce, cornstarch, salt, pepper) on the enamel at the heating zone and letting it burn for 10 min at a power corresponding to a hot spot of 420° C. Said hot spot is the average of measurements taken using a thermocouple on the underside of a pan and a thermal camera on the top, placed after the pan has been removed from the glass-ceramic article. This step is repeated 5 times. After the 1^{st} and 5^{th} cycles, the glass-ceramic surface is cleaned using a scraper, a non-abrasive pad, and a glass-ceramic cleaning product. The extent of enamel peeling is then observed, and a score is assigned to the sample from 0 (no peeling) to 5 (peeling over the entire surface tested).

FIG. 4 shows the results of the peeling tests for comparative 3 and example 5 according to the invention.

When comparing:
examples 2 and 4 according to the invention with comparative 1,
example 5 according to the invention with comparative 3,
examples 7 and 8 according to the invention with comparative 4,
   the addition of talc to a glass frit in a enamel results in improved peeling resistance

In particular, the peeling resistance of the IB2 glass frit-containing enamels shown in comparatives 3 and 4 is significantly improved by the addition of talc, as observed in examples 5, 7 and 8.

The abrasion resistance of enamels according to the invention has also been tested according to two protocols reported in Table 5 below as “Manual Test” and “Taber Test”.

| | | Ex. 9 | Ex. 10 | Ex. 11 | Ex. 12 | Ex. 13 | Ex. 14 |
|---|---|---|---|---|---|---|---|
| Glass | IB2 (D90 = | 70 | 75 | — | — | 80 | — |
| frit | 10.9 μm) | | | | | | |
| | IB2 (D90 = | — | — | 75 | 75 | — | 80 |
| | 3.16 μm) | | | | | | |

| | | | | | | |
|---|---|---|---|---|---|---|
| Talc (DC8345 from | 30 | 25 | 25 | 25 | 20 | 20 |
| Normag GmbH) | | | | | | |
| (D90 = 30 μm) | | | | | | |
| Attrition (min) | — | 120 | 120 | 120 | 120 | 120 |
| D90 (μm) | 5.9 | 6.1 | 5.7 | 5.7 | 5.4 | 4.0 |
| Thickness (μm) | 2.75 | 2.00 | 1.80 | 3.80 | 3.25 | 3.00 |
| Manual test | 2 | 2 | 1 | 2 | 0 | 0 |
| Taber test | 3 | 4 | 3 | 3 | 2 | 1 |

The enamel compositions of Examples 9 to 14 according to the invention are obtained in the same way as the compositions previously described.

The mixture is screen-printed on Kerablack+ mother glass from Eurokera S.N.C., then fired via a ceramizing cycle at 930° C. to obtain a glass-ceramic plate sample. The thickness of the deposit is then measured.

The abrasion test protocols are as follows:
Manual test: 1 mL of VitroClen brand product from Reckitt Benckiser is applied to a point on the glass-ceramic sample to be tested. Cleaning is then simulated by scrubbing back and forth 100 times over a distance of 10 cm using a Scotch Brite Blue sponge and pad sold by 3M. After cleaning, the test surface is wiped clean with a cloth and glass cleaner, before the enamel abrasion is assessed by assigning a contrast score to the sample, ranging from 0 to 5, in relation to the original state of the enamel, where 0 denotes undamaged enamel, 1 denotes particularly good abrasion resistance, 2 denotes good abrasion resistance, 3 denotes acceptable enamel abrasion, 4 denotes poor abrasion resistance and 5 denotes completely abraded enamel.
Taber test: This test uses a Linear Abraser type abrasimeter sold by Taber, on which is mounted an 18 mm disc fitted with a white Veraclen Critical Cleaning PL WIP 74603 cloth marketed by Chicopee. The abrasimeter is set up to apply a pressure of 5 N·cm⁻² to the disc, causing it to move back and forth (or cycle) at a speed of 60 cycles per minute over a stroke of 38.1 mm. 1 mL of VitroClen sold by Reckitt Benckiser is applied to a point on the glass-ceramic sample to be tested. The abrasimeter is then activated to go back and forth 500 times. The test surface is wiped clean with a cloth and glass cleaner, before the operator assesses the enamel abrasion by assigning a contrast score to the sample, ranging from 0 to 5, in relation to the original state of the enamel, where 0 denotes undamaged enamel, 1 denotes particularly good abrasion resistance, 2 denotes good abrasion resistance, 3 denotes acceptable enamel abrasion, 4 denotes poor abrasion resistance and 5 denotes completely abraded enamel.

From the tests described above, it appears that an enamel composition according to the invention containing 20% talc by weight, relative to the total weight of the enamel, has particularly satisfactory abrasion resistance.

Furthermore, a comparison of the Taber test results of Examples 13 and 14 shows that the smaller the grain size of the glass frit used, the better the abrasion resistance of the resulting enamel.

1. An enamel composition for a glass-ceramic article comprising glass and talc.

2. The enamel composition according to claim 1, wherein the talc is present in a proportion ranging from 5% to 40% by weight relative to the total weight of the enamel.

3. The enamel composition according to claim 1, comprising less than 1% by weight of pigments relative to the total weight of the enamel, and preferably the enamel is pigment-free.

4. The enamel composition according to claim 1, wherein the enamel is obtained from a mixture of frit of glass and talc having a D90 of less than 20 μm.

5. The enamel composition according to claim 1, wherein the glass is of the following composition
SiO₂: 35-50%
B₂O₃: 23-30%
Al₂O₃: 10-22%
Li₂O: 1-3%
Na₂O: 0-3%
K₂O: 2-5%
Li₂O+Na₂O+K₂O: <8%
CaO: 1-5%
CaO+MgO+ZnO+BaO+SrO: <7%
TiO₂: 0-2%
ZrO₂: 0-5%
the proportions being expressed as percentages by weight relative to the total weight of glass.

6. The enamel composition according to claim 5, wherein the glass has a coefficient of thermal expansion less than or equal to
60×10⁻⁷ K⁻¹.

7. The enamel composition according to claim 5, wherein the glass has a softening point T_{L} above 650° C.

8. The enamel composition according to claim 5, comprising talc in a proportion ranging from 15% to 40% by weight relative to the total weight of the enamel.

9. The enamel composition according to claim 1, wherein the glass is of the following composition, the proportions being expressed as weight percentages relative to the total weight of glass:
SiO₂ 45-60%,
Al₂O₃ 12-22%,
B₂O₃ 12-22%,
Li₂O 0-5%,
Na₂O 0-2%,
K₂O>2%,
CaO 0-4%,
MgO 0-4%,
ZnO 0-4%,
BaO 0-4%,
ZrO₂ 0-4%,
TiO₂ 0-1%,
the sum of the proportions of the oxides
CaO+MgO+BaO+SrO+ZnO
is furthermore less than or equal to 10%.

10. The enamel composition according to claim 9, comprising talc in a proportion ranging from 5% to 30% by weight relative to the total weight of the enamel.

11. A method for obtaining an enamel composition according to claim 1 comprising mixing a frit of glass and talc, and optionally attrition of the resulting mixture for a period ranging from 5 minutes to 1 hour.

12. A glass-ceramic article comprising at least one substrate, said at least one substrate being at least partly coated with an enamel composition according to claim 1.

13. A method for obtaining a glass article according to claim 12, comprising:
a. providing a glass-ceramic substrate,
b. printing an enamel composition according to claim 1 onto said substrate, and
c. ceramizing the assembly of the substrate and the enamel.

14. The enamel composition according to claim 2, wherein the talc is present in a proportion ranging from 7% to 35% by weight relative to the total weight of the enamel.

15. The enamel composition according to claim 3, comprising less than 0.5% by weight of pigments relative to the total weight of the enamel, and preferably the enamel is pigment-free.

16. The enamel composition according to claim 4, wherein the enamel is obtained from a mixture of frit of glass and talc having a D90 of less than 15 μm.

17. The enamel composition according to claim 6, wherein the glass has a coefficient of thermal expansion less than or equal to 56×10⁻⁷ K⁻¹.

18. The enamel composition according to claim 7, wherein the glass has a softening point T_{L} above 680° C.

19. The enamel composition according to claim 8, comprising talc in a proportion ranging from 17% to 35% by weight relative to the total weight of the enamel.

20. The enamel composition according to claim 10, comprising talc in a proportion ranging from 7% to 20% by weight and relative to the total weight of the enamel.

21. The method according to claim 13, wherein the ceramizing comprises heating the substrate and enamel assembly at a temperature of 650° C. to 830° C. for 5 to 90 minutes, then at a temperature of 850° C. to 1100° C. for 5 to 30 minutes.
